(19) United States
(12) Patent Application Publication
(10) Pub. No.: US 2003/0163696 A1
(43) Pub. Date: Aug. 28, 2003

(54) Device for controlling an identity document or the like

(76) Inventor: Sandrine Rancien, La Murette (FR)

Correspondence Address: Oliff & Berridge, P O Box 19928, Alexandria, VA, 22320, US

(21) Appl. No.: 10/343,059

(22) PCT Filed: Jul. 31, 2001
(86) PCT No.: PCT/FR01/02497

(30) Foreign Application Priority Data
Aug. 2, 2000 (FR) 00 10195

(51) Int. Cl. H04L 9/00

(52) U.S. Cl. 713/170

(57) ABSTRACT

Apparatus (1) for inspecting an identity document (10) or the like, such as an identity card or a passport, the document having at least one transponder and a code (17), the inspection apparatus being characterized by the fact that it comprises a radiofrequency device (3) serving during an identity check to read and optionally program the transponder (11), at least one code reader (4) adapted to the type of code used by the document, the reader comprising code scanning means and a decoder for processing the scanned data, and data management means (2) enabling the information delivered by the radiofrequency device to be compared with the information delivered by the code reader (4) in order to authenticate the identity document and/or verify that the bearer of the document is indeed the authorized holder thereof, the data management means (2) preferably being arranged to enable the code reader and the radiofrequency device to operate simultaneously.

The present invention relates to apparatus for inspecting an identity document or the like, such as an identity card or a passport.

In general, an identity document carries not only a photograph in the form of a photographic medium or a printed image, but also printed data relating to the bearer.

Identity is conventionally verified by comparing the photograph present on the identity document with the face of the bearer of the document.

Unfortunately, that type of verification is insufficient because of the possibility of substituting the photograph of the bearer with another photograph and/or of falsifying the printed information relating to the bearer.

As a result, additional security has been provided in certain identity documents such as passports and identity cards. This security consists in a printed code which is readable optically and automatically by means of an appropriate reader. The code contains information relating to the bearer of the document in encoded form. The code may be printed in ink that is visible or invisible to the eye. The reader may also automatically scan printed information that is present on the document but that is not encoded and then compare that information with the encoded information so as to reveal any attempt at falsification.

In the particular case of passports, the code is in the form of a line of characters that are optically readable in automatic manner, and said line of characters, on being decoded, gives information relating to the bearer of the document; this optical character reader (OCR) line is standardized (ISO 1831-1980) and enables passports to be read automatically for the purpose of detecting possible falsification. Such apparatus for reading an OCR line is available, for example, under the trademark DILETTA® TDR 200, and the data derived from the decoding can be compared visually with the data printed on the document.

With documents such as identity cards, there is no standardization and various types of printable code are available on the market, such as those described for example in the document “Counterfeit, deterrence, product authentication, and protection of brand identity”, published by Label and Labelling Consultancy. Two-dimensional array codes are to be found, for example, such as the Datastrip® code which enables information such has a photograph, a signature, a fingerprint, or any other biometric information concerning the bearer of the identity card to be encoded. There also exist codes that are simpler such as the IDData Matrix® code for encoding a string of characters. With appropriate readers constituted by apparatus for reading and decoding the code, it is then possible to recover the information in decoded form and to compare it with the information present on the document in order to reveal any attempt at falsification.

French patent application FR-A-2 776 153 describes a method in which the photograph of a person and information relating to that person are digitized and stored in an electronic chip integrated in the document. When identifying the bearer of the document, the information stored in the chip is read and displayed on a screen to enable an operator to compare said data with the photograph present on the document. Where appropriate, the information, including the photograph, printed on the document is scanned during inspection by means of a scanner and is analyzed by recognition software. The information read from the chip is then compared automatically with the information coming from the scan and a message is displayed on the screen to warn of any possible differences.

There exists a need to further increase the number of security features used.

Nevertheless, inspection operations quickly become time consuming when a large number of security features need to be examined.

In addition, if identity-checking operations are lengthy and time consuming, they are liable to lead to the buildup of lines that might discontent people.

There thus exists a need to enable identity documents to be inspected quickly and easily.

There also exists a need to improve the reliability of identity checks.

The invention seeks in particular to make it easier to authenticate identity documents, but without that requiring the use of complex and expensive equipment.

The invention achieves this by means of apparatus for inspecting an identity document or the like, such as an identity card or a passport, the document having at least one transponder and a code, the inspection apparatus being characterized by the fact that it comprises a radiofrequency device serving during an identity check to read and optionally program the transponder, at least one code reader adapted to the type of code used by the document, the reader comprising code scanning means and a decoder for processing the scanned data, and data management means enabling the information delivered by the radiofrequency device to be compared with the information delivered by the code reader in order to authenticate the identity document and/or verify that the bearer of the document is indeed the authorized holder thereof, the data management means preferably being arranged to enable the code reader and the radiofrequency device to operate simultaneously.

The inspection apparatus thus makes it possible to verify that the information derived from data recorded in the transponder is identical to or agrees with information that results from data printed on the document.

Operating the code reader and the radiofrequency device simultaneously enables time to be saved, the transponder being read and/or programmed while the data of the code is being recognized.

By way of example, the code reader may comprise a scanner or a charge-coupled device (CCD) camera, together with special lighting when codes are printed using ultraviolet (UV) or infrared (IR) inks.

In the invention, so long as entire images are not stored, the volume of data can be small and the electronics of the data acquisition device can be relatively simple and inexpensive while still enabling data to be processed quickly.

In addition, since the data acquisition device is a code reader, existing code readers can be used directly or with little modification, thus making it possible to increase the security of inspection without requiring large amounts of investment.

The inspection apparatus may include at least one optical and/or magnetic and/or electrical sensor suitable for detecting and/or identifying a security element present on the document, in order to authenticate it.

By way of example, such a security element may be constituted by a tracer which is detectable on being excited under ultraviolet, infrared, microwave, or magnetic field radiation.

Advantageously, the inspection apparatus includes audible and/or luminous warning means for automatically indicating the presence of an anomaly concerning document authentication and/or correspondence between information delivered by the code reader and information delivered by the radiofrequency device.

The monitoring apparatus is preferably in the form of a one-piece unit or in the form of a plurality of devices assembled together in such a manner as to enable them to be moved simultaneously.

The inspection apparatus may include a window arranged to enable the document to be placed thereon, or a slot into which the document may be inserted.

The radiofrequency device may be integrated in the same housing as the code reader, as may the data management means.

Thus, the code reader and the radiofrequency device may constitute a unitary structure, e.g. in the form of a single station or device.

The ability to read and/or program the transponder by placing it on a window facilitates the work to be performed by the person carrying out identity checks, since it is easy to bring the document into a configuration that enables the transponder to be read and/or programmed while simultaneously verifying the inscriptions present on the document and/or while applying a customs stamp.

Any risk of error due to a document being taken from one station to another is then non-existent.

The transponder may be integrated in the thickness of the paper or the plastics material of the document.

Advantageously, the inspection apparatus further comprises printer means suitable for printing on the document.

The printer means may be used, for example, to print a customs stamp on a passport.

The printer means may be arranged so as to begin printing before the end of data exchange between the transponder and the radiofrequency device, or in a variant the radiofrequency device may be arranged to exchange data with the transponder before the end of printing.

This serves to save time.

The invention also provides an identity document including a printed code, a security element such as an optically variable device, a watermark, or microperforations, for example, and a transponder in which data representative of the code is stored, the transponder being arranged to be capable of exchanging data with inspection apparatus as defined above.

In an embodiment of the invention, the transponder does not store a full image of the authorized holder of the document, thus making it possible to use a transponder that is relatively simple and inexpensive.

Other characteristics and advantages of the present invention appear on reading the following detailed description of non-limiting embodiments, and on examining the accompanying drawing, in which:

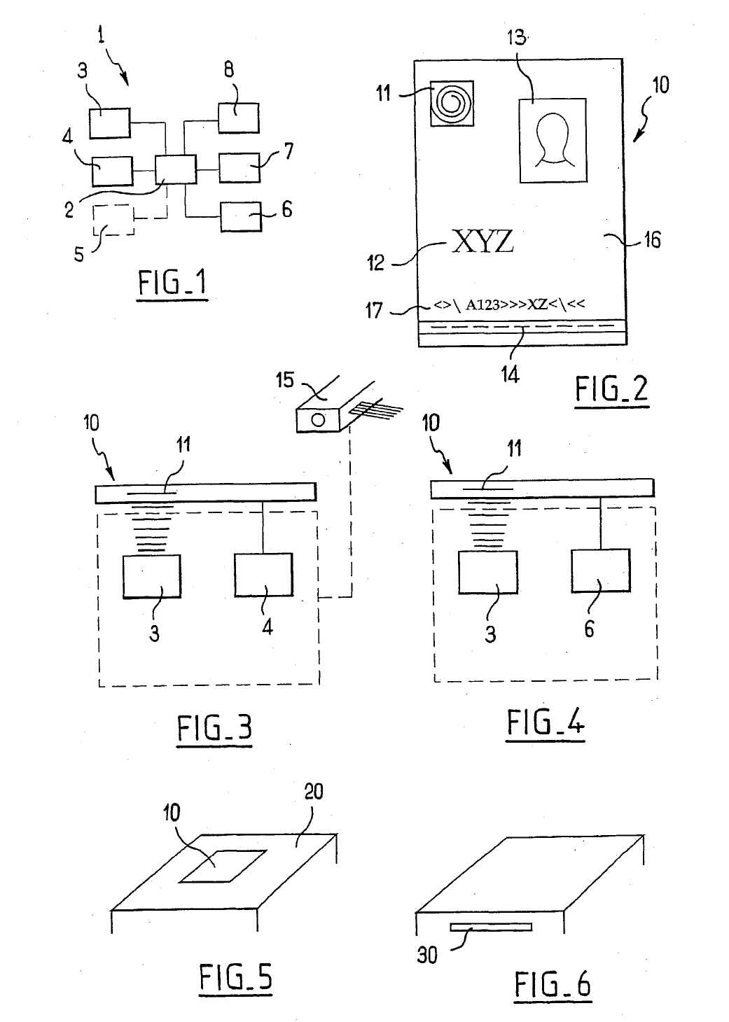

FIG. 1 is a highly simplified diagram of inspection apparatus of the invention;

FIG. 2 shows an identity document for reading by the FIG. 1 apparatus;

FIG. 3 shows the reader of the transponder and of information carried on the document;

FIG. 4 shows writing in the transponder and printing on the document;

FIG. 5 is a fragmentary diagrammatic view of a window on which an identity document in accordance with the invention can be placed; and

FIG. 6 shows a variant embodiment of the unit.

FIG. 1 shows inspection apparatus 1 in accordance with the invention comprising data management means 2, a radiofrequency device 3 for reading and writing in the transponder, an acquisition device 4 constituted by a code reader, a printer 6, and an audible or light-emitting warning device 7. The data management means 2 may also be connected to a monitor screen 8.

The code reader 4 comprises a scanner for scanning the code and a decoder for analyzing the scanned data and for decoding it.

The data management means 2 control overall operation and are constituted, for example, by an electronics card including a microprocessor, the card being received in the same housing 20 as the code reader, part of the housing being shown in FIG. 5.

The housing 20 includes a transparent window on which an identity document 10 as shown in FIG. 2 can be placed, and it incorporates an antenna enabling information to be exchanged with a transponder integrated in the document 10.

The document 10 comprises a medium 16, e.g. made of thick paper such as the cover sheet of a passport, having the transponder 11 fixed thereto and also having alphanumeric data 12 printed thereon, e.g. a string of words, letters, or digits relating to the identity of the bearer of the document 10.

A photograph 13 and a security element 14 are also present on the medium 16.

The transponder 11 comprises an antenna and an electronic circuit of a kind that is known per se.

In this case the security element 14 is constituted by an iridescent strip.

In addition to the alphanumeric data 12, the document 10 also carries a code 17 constituted in this case by an OCR line, the code being established by means of a standardized algorithm.

The conventional code 17 may be replaced by and/or associated with a bar array code distributed over the document, or by other codes as mentioned above.

When the identity document 10 is being verified, it is placed on the window of the housing 20, as shown in FIG. 5.

The radiofrequency device 3 then reads remotely and optionally decrypts the information stored in the transponder 11 while the scanner of the code reader acquires an image of all or part of the printed data (readable in natural light or otherwise) present on the document, and while the decoder of the code reader decodes the data corresponding to the code. The code reader may be suitable for reading in the infrared and/or in the visible.

The data picked up by the code reader and by the radiofrequency device 3 is processed by the data management device 2.

The data coming from the code reader 4 is compared in the example described with data recorded in the transponder, relating to the data constituting the subject matter of the code, thus making it possible to detect a possible attempt at falsifying information if the data does not match.

The expiry date of the identity document can also be verified automatically.

In the example described, the radiofrequency device 3 makes it possible not only to read the information contained in the transponder 11, but also to program the transponder, as shown in FIG. 4.

Thus, it is possible to record additional data in the transponder 11, for example a date of entry to a territory.

Where appropriate, the printer 6 may be used to print a stamp on the identity document 10, e.g. including the date of verification.

In the example described, printing takes place on the document 10 while data is being exchanged between the transponder 11 and the radiofrequency device 3, thus saving time.

Naturally, the invention is not limited to the description above.

It is possible in particular for the inspection apparatus 1 to include a magnetic and/or optical and/or electrical sensor 5 serving, for example, to detect and/or identify a security element present on the security document.

Instead of using a scanner, it is possible to use a camera.

The camera need not be integrated in a housing behind a transparent window, but may be placed above a reception surface on which the identity document is placed while the transponder is being read and/or programmed.

The identity document may then be printed by means of a print head placed above the above-mentioned reception surface.

It is also possible to replace the unit having a window with a unit fitted with a slot 30 or a read inlet, as shown in FIG. 6.

1/ Apparatus (1) for inspecting an identity document (10) or the like, such as an identity card or a passport, the document having at least one transponder and a code (17), the inspection apparatus being characterized by the fact that it comprises a radiofrequency device (3) serving during an identity check to read and optionally program the transponder (11), at least one code reader (4) adapted to the type of code used by the document, the reader comprising code scanning means and a decoder for processing the scanned data, and data management means (2) enabling the information delivered by the radiofrequency device to be compared with the information delivered by the code reader (4) in order to authenticate the identity document and/or verify that the bearer of the document is indeed the authorized holder thereof, the data management means (2) preferably being arranged to enable the code reader and the radiofrequency device to operate simultaneously.

2/ Apparatus according to claim 1, characterized by the fact that the code reader and the radiofrequency device constitute a unitary structure.

3/ Apparatus according to claim 2, characterized by the fact that the radiofrequency device (3) is integrated in the housing (20) of the code reader (4).

4/ Apparatus according to any one of claims 1 to 3, characterized by the fact that it includes a window arranged to enable the identity document (10) to be placed thereon.

5/ Apparatus according to any one of claims 1 to 3, characterized by the fact that it includes a slot (30) enabling the document to be inserted therein.

6/ Apparatus according to any one of claims 1 to 5, characterized by the fact that it includes at least one optical and/or magnetic and/or electrical sensor (5) suitable for detecting and/or identifying a security element (14) present on the document in order to authenticate it.

7/ Apparatus according to any one of claims 1 to 6, characterized by the fact that the transponder (11) is integrated in a thickness of paper or plastics material of the document.

8/ Apparatus according to any preceding claim, characterized by the fact that it includes an audible and/or luminous warning device (7) for automatically indicating the presence of an anomaly concerning authentication of the identity document and/or matching between the information delivered by the code reader and the information delivered by the radiofrequency device (3).

9/ Apparatus according to any preceding claim, characterized by the fact that it includes printer means (6) for printing on the identity document (10).

10/ Apparatus according to the immediately preceding claim, characterized by the fact that the printer means (6) are arranged to begin printing before the end of data exchange between the transponder (11) and the radiofrequency device (3).

11/ Apparatus according to claim 10, characterized by the fact that the radiofrequency device (3) is arranged to exchange data with the transponder (11) before the end of printing.

12/ An identity document (10) including a printed code (17), a security element (14) such as an optically variable device, a watermark, or microperforations, and a transponder (11) in which data representative of the code is stored, the transponder being arranged to be capable of exchanging data with the inspection apparatus (1) as defined in any preceding claim.

13/ A document according to the preceding claim, characterized by the fact that the identity number of the transponder is stored therein, said number being also engraved on the circuit of the transponder.

14/ A document according to claim 12 or claim 13, characterized by the fact that the transponder (11) does not store an entire image of the authorized holder of the document.
